(19) United States
(12) Patent Application Publication
(10) Pub. No.: US 2010/0303265 A1
(43) Pub. Date: Dec. 2, 2010

(54) ENHANCING USER EXPERIENCE IN AUDIO-VISUAL SYSTEMS EMPLOYING STEREOSCOPIC DISPLAY AND DIRECTIONAL AUDIO

(75) Inventor: Gunjan Porwal, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/474,284

(22) Filed: May 29, 2009

(51) Int. Cl. H04R 5/02

(52) U.S. Cl. 381/306; 348/42

(57) ABSTRACT

An audio-visual system providing a directional audio stream corresponding to an element in a same direction the element is rendered in a stereoscopic display. As a result, the audio stream may be audible only in portion of an area in the direction the element is rendered. Developers of audio-visual content can creatively use such a feature to enhance user experience as suited in the specific environment. In an embodiment, an object data provided for an element specifies whether the directional audio is to be sent in the same direction the element is rendered. Accordingly, the audio and rendered direction may be aligned only for some of the elements in a scene. In a scenario in which the audio-visual system corresponds to a game console, user interaction may determine the direction of an element, and thus both visual and audio directions are accordingly set.

### BACKGROUND OF THE INVENTION

1. Technical Field

The present disclosure relates to audio-visual systems and more specifically to enhancing user experience.

2. Related Art

An audio-visual system refers to a system in which sequence of images are displayed while audio stream is played. In general, images are displayed in a screen for viewing by several viewers, while audio stream is played using appropriate sound output devices such as speakers.

There are several audio-visual systems that employ stereoscopic display. Stereoscopic display implies that the viewers have visual perception in all three dimensions, i.e., viewers are able to clearly have the depth perception as well. Stereoscopic displays work by producing two different images of the same view, at the same time, one for the left eye, and another for the right eye. These two images are displayed simultaneously on the screen, and the underlying technology enables the images to reach the corresponding eyes, i.e., the left image reaches the left eye, and the right image reaches the right eye. The brain combines these two images and gives the viewer the perception of depth, as if the object is coming out of screen.

Directional audio is also known employed in audio-visual systems. Directional audio implies that the audio is broadcast for listening in only a specific desired direction such that only viewers/ users in an area covered by that direction can hear the audio being broadcast. Various technologies may be used to further restrict the specific set of users who can listen to the audio stream (by requiring appropriate equipment to demodulate/decode the modulated signal), though there are other users are there in the covered area.

In one prior embodiment, directional audio is achieved by modulation of the original audio stream (sought to be broadcast) with an ultrasound signal, and then using ultrasound transducers to project the combined signal in a desired/specific direction. Since ultrasound is directional in nature, the combined audio stream would travel in a straight direction. The air surrounding a user acts as a demodulator for the combined signal, and separates the original audio stream signal from ultrasound signal, thereby enabling people in the broadcast direction to hear the original audio stream. An example implementation of such a technique is available in Audio Spotlight product available from Holosonics, 400 Pleasant Street, Watertown, Mass. 02472.

There is a general need to enhance user experience with audio-visual systems. User experience, in general, represents the overall experience a user has while viewing/listening to the audio-visual content provided by the audio-visual systems.

### BRIEF DESCRIPTION OF THE DRAWINGS

Example embodiments of the present invention will be described with reference to the accompanying drawings briefly described below.

FIG. 1A is a block diagram illustrating the details of an example stereoscopic gaming environment in which several aspects of the present invention can be implemented.

FIG. 1B is an example scene rendered on a stereoscopic display unit in an embodiment of the present invention.

FIG. 2 is a flow chart illustrating the manner in which user experience in audio-visual systems employing stereoscopic display and directional audio can be enhanced according to an aspect of the present invention

FIG. 3 is a block diagram illustrating the details of a game console in an embodiment of the present invention.

FIG. 4A is an example object definition in an embodiment of the present invention.

FIG. 4B is an example representation of direction associated with objects in an embodiment of the present invention.

FIG. 5 is a block diagram illustrating the details of a digital processing system in which several features of the present invention are operative upon execution of appropriate software instructions in an embodiment of the present invention.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

1. Overview

An audio-visual system provided according to an aspect of the present invention provides a directional audio stream corresponding to an element in a same direction the element is rendered in a stereoscopic display. As a result, the audio stream may be audible only in portion of an area in the direction the element is rendered. Developers of audio-visual content can creatively use such a feature to enhance user experience as suited in the specific environment.

In an embodiment, an object data provided for an element specifies whether the directional audio is to be sent in the same direction the element is rendered. Accordingly, the audio and rendered direction may be aligned only for some of the elements in a scene.

In a scenario in which the audio-visual system corresponds to a game console, user interaction may determine the direction of an element, and thus both visual and audio directions are accordingly set.

Several aspects of the invention are described below with reference to examples for illustration. However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

2. Example Environment

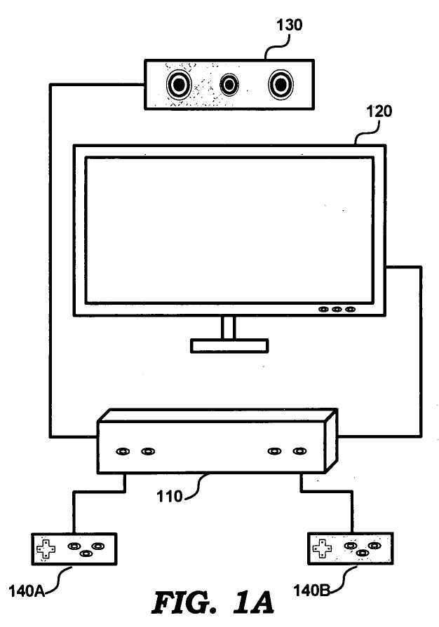

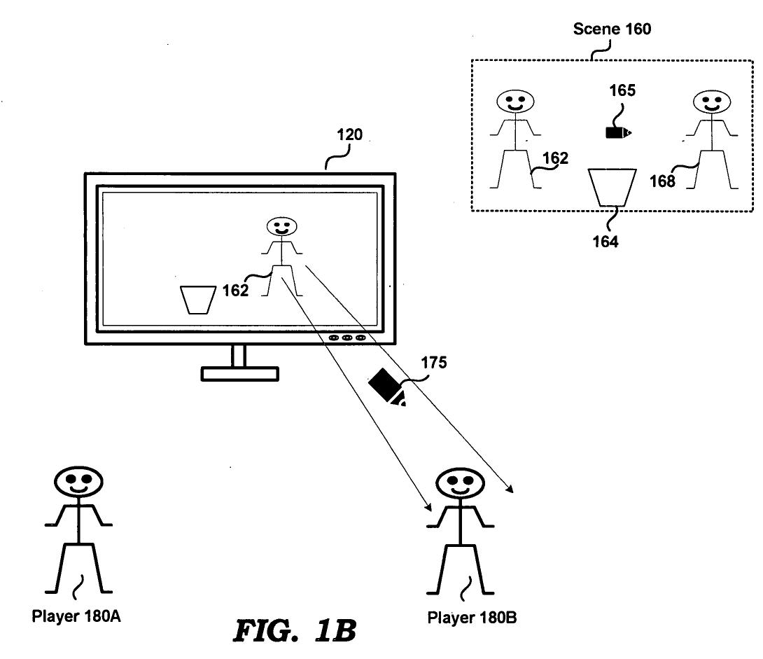

FIG. 1A is a block diagram illustrating an example audio-visual system (gaming system) in which several aspects of the present invention can be implemented. While the features are described below with respect to gaming system merely for illustration, it should be understood that the features can be implemented in other types of audio-visual systems, in particular, without the user interaction common in gaming systems.

The block diagram is shown containing game console 110, stereoscopic display unit 120, directional audio output device 130 and game controllers 140A-140B. Merely for illustration, only representative number/type of systems/components is shown in the Figure. Many environments often contain many more systems, both in number and type, depending on the purpose for which the environment is designed.

Game console 110 represents a system providing the necessary hardware (in addition to any required software) environment for executing game applications. While the hardware provides the necessary connections/association between game console 110 and other systems and input/output devices such as display unit 120, audio output device 130, game controllers 140A-140B etc., the software environment provides the necessary interface between the game console and other devices. The software includes operating system, drivers for interfacing with input/ output devices.

In addition, game console 110 may contain a non-volatile storage such as a hard disk drive and may also contain the necessary drives/ slots wherein a user can load corresponding media storing the game application. Further, game console 110 receives inputs from game controller 140A and sends images for rendering to display unit 120, audio for reproduction to audio output device 130 via corresponding hardware and interfaces.

Each of game controllers 140A-140B represents an input device primarily for providing inputs according to specific implementation of the game/ game application. For example, specific controls in game controllers are to be pressed for performing specific functions (e.g., to shoot a bullet with a displayed gun, to accelerate a car, etc.) in a corresponding game. In one embodiment, the game controllers are designed to provide force feedback (e.g. vibrate) based on the data received from game console 110. For example, game controllers 140A-140B include devices such as mouse, keyboard, generic game pad, etc., or a special controllers used with specific game applications such as wheel, surfboard, guitar etc. Game controllers 140A-140B may be associated/ connected with game console 110 either in a wired or wireless manner.

Stereoscopic display unit 120 provides for stereoscopic display of at least some displayed elements. The unit is shown associated with game console 110 indicating that game console 110 provides the data to be rendered on the display unit and accordingly stereoscopic display unit 120 renders the images. Any necessary accessories (e.g., special goggles/viewing glasses) may be used by users to experience the depth perception of the rendered images. In particular, the some of the elements rendered on the display unit appear to emerge from the screen in a specific direction.

Directional audio output device 130 is shown associated with game console 110 indicating that game console 110 sends directional audio data associated with the element(s) and audio output device 130 produces/broadcasts the audio stream in the desired specific direction. Audio output device 130 is assumed to contain any necessary mechanical/electrical/electronic/other components required for delivering directional audio in a desired direction, and can be implemented in a known way.

The description is continued illustrating the manner in which user experience in stereoscopic gaming, using directional audio is provided with respect to an example scene in a game.

3. Example Scene/Game

FIG. 1B represents an example scene from a sample game application rendered on a stereoscopic display unit. Accordingly, portion 160 corresponds to a scene in the game application (example: “shooting game application”) shown containing various elements—role A (162), role B (168), a bullet (165) and a flower pot (164). It is assumed that role A represents a character in the game, while role B is played by (and thus controlled by) player 180B.

A scene represents a snapshot of current status of the elements involved in the game at a specific time instance. It should be appreciated that a scene would typically contain many more types/number of elements (potentially of the order of thousands based on the game application) and rendered images (of the scene) may contain only some of the elements depending on the view (typically of the player) that is being represented. All the elements in scene 160 are assumed to be rendered on stereoscopic display unit 120 in a three-dimensional (3-D) manner.

In the example scene 160, the time instance corresponds to the occurrence of event representing “role A (162) shoots a bullet (165) at role B (168)” and it is assumed that the view of player 180B is being presented. Accordingly, the images corresponding to elements role A 162 and flower pot 164 are shown rendered on the screen, while the element bullet 165 is rendered as emerging towards player 180B for corresponding user experience. Thus, player 180B will have the perception of a “Bullet” emerging out of the display unit directly towards him/her as indicated by display portion 175, and thus the desired stereoscopic effect.

It should be appreciated that player 180A, if viewing the same display (using any necessary glasses, etc., for stereoscopic effect), would see the bullet going in the general direction of player 180B.

It may accordingly (consistent with the stereoscopic display) be desirable that the sound (broadcast by the directional audio output device 130) also be provided correlated with “bullet” as indicated in display portion 175. The term ‘correlated with’ would have one or more of experience parameters such as sound being synchronous with the rendering of the element/bullet, the sound being directional, and the volume of the sound being depending on the location of the element/bullet in relation to the specific user, etc.

Several aspects of the present invention provide for enhanced user experience in audio-visual systems (such as gaming) employing stereoscopic display and directional audio, as described below with examples.

4. Enhancing User Experience

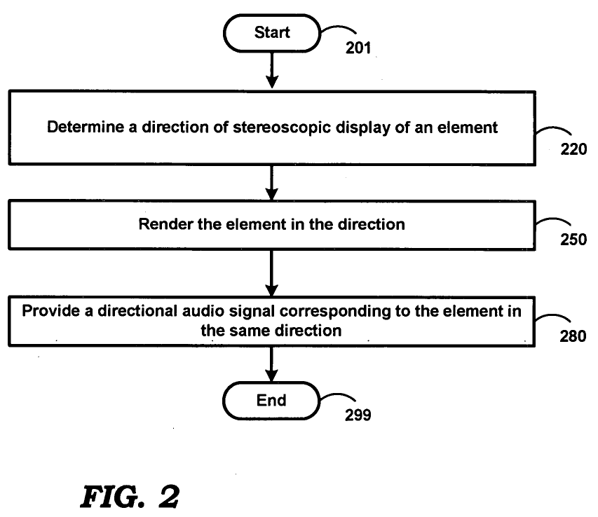

FIG. 2 is a flow chart illustrating the manner in which user experience in audio-visual systems (such as gaming) employing stereoscopic display and directional audio can be enhanced according to an aspect of the present invention. The flowchart is described with respect to FIGS. 1A and 1B merely for illustration, with the steps described as being performed by game console 110. However, various features can be implemented in other environments also (with the steps being performed by a corresponding audio-visual system) without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 220.

In step 220, game console 110 (or the game application) determines a direction of stereoscopic display of an element. The determination of the direction may be performed dynamically based on the interaction (e.g. in response to a user input) associated with the element. For example, the direction of stereoscopic display of element bullet 165 in scene 160 may be determined in response to the action of the element role A 162 firing the bullet towards role B 168 (representing player 180B).

It should be appreciated that the direction can be specified using various approaches, taking into account the specific context in which the element is rendered. Thus, if the element needs to be included in multiple scenes of the game application, the developer may associate specific corresponding direction for each corresponding instance of the element.

In one embodiment, the determined direction is stored as a value of a direction attribute contained in an object data for the element (being rendered). As is well known in game programming environments, each element type (e.g., role type, bullet type, etc.) is defined by a corresponding object definition containing corresponding attributes. The attributes may be populated with desired values to specify the object data for each element type/instance.

In another embodiment, a developer (of the game application) is enabled to specify static values for the direction attributes for different element types/instances. Accordingly, the determination of above is performed by retrieving the static value for the direction attribute contained in the object data corresponding to the element.

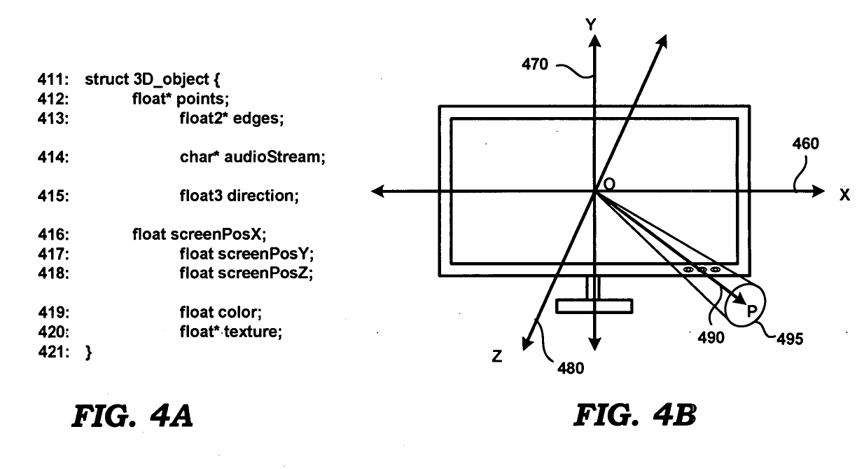

The object data may contain additional attributes, for example to specify the audio stream (to be played as audio), the dimensions, color, texture, etc. and direction in accordance with the specific object definition. An example object data is described below in detail in an embodiment with reference to FIG. 4A.

The object data thus provided by the developer can be included in the executables of the game application or alternatively, be stored in data storage such that while executing the game, game console 110 may access the object data as required (for example, for determination of direction, while rendering the element, for retrieving the audio stream to be played/broadcast).

In step 250, game console 110 (or the game application) renders the element in the determined direction, according to a gaming logic being implemented. In general, rendering implies generating display signal to cause one or more images to be displayed on a display screen. In digital processing systems, such rendering is typically performed based on image data representing an image frame to be displayed.

The elements of a scene may be rendered using the various specifications/attributes in the corresponding object data (if such object data is specified) or based on other logic, as suited for the specific environment. For example, an instance of the object may be instantiated based on attributes (for rendering of the element in a stereoscopic display) in corresponding object data prior to such rendering of the element is performed. It should be further appreciated that the elements of the scene and the content of the scene otherwise, may further be defined by the various user interactions and the program logic implementing the underlying game.

In step 280, game console 110 (or the game application) provides a directional audio signal corresponding to the element in the same direction. The directional audio signal may be generated based on the audio stream associated with the element (as specified in the object data for the element in the scene). The manner in which the direction is controlled depends on the underlying audio technology. In the case of using modulation based techniques noted above, the frequency and/or the coordinate direction of the audio signal may be controlled to obtain the specified direction. Thus, the audio provided is audible to only desired players/spectators. For example, the noise associated with the bullet fired towards role 168 may be sent only to player 180B (and not to player 180A). The flow chart ends in step 299.

It may thus be appreciated that the directional audio can be provided in step with stereoscopic display of the same element, thereby enhancing the user experience. Such features can be taken advantage of by various games according to corresponding designs.

Further, by providing developers the control of specifying the audio direction, the creativity of the developers of individual element can be used to enhance the user experience. The control is particularly relevant when different types of control are desired associated with different element types.

While the features of the flowchart are described with respect to FIG. 1B merely for illustration, it should be appreciated that complex games will be able to use the features of the present invention, as suited for the corresponding gaming logic. Furthermore, the features described above may be implemented using various architectures/approaches, as described below with respect to an example implementation.

5. Example Implementation

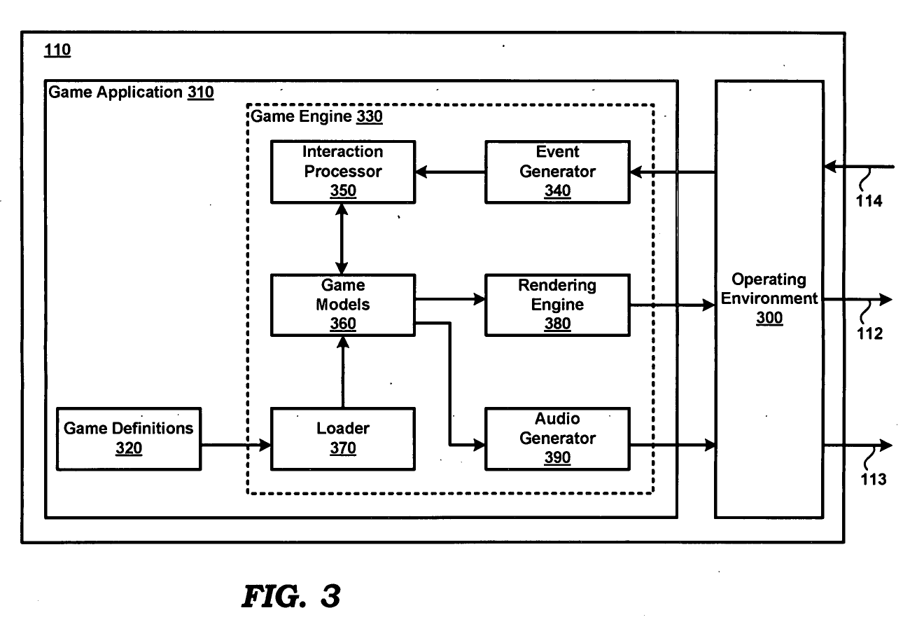

FIG. 3 is a block diagram of an example implementation of game console 110 in one embodiment. Game console 110 is shown containing operating environment 300, and game application 310. The game application is shown containing game definitions 320 and game engine 330. Game engine 330 is shown containing event generator 340, interaction processor 350, game models 360, loader 370, rendering engine 380 and audio generator 390.

For illustration, only representative blocks (in type and number) are shown, though alternative embodiments in accordance with several aspects of the present invention can contain other blocks. Each block may be implemented as an appropriate combination of one or more of hardware (including integrated circuit, ASIC, etc.), software and firmware. Each of the blocks is described in detail below.

Operating environment 300 represents necessary software/hardware modules providing a common environment for execution of game applications. Operating environment 300 may include operating systems, virtual machines, device drivers for communicating (via paths 112-114) with input/output devices associated with game console 110, etc. Operating environment 300 may further include load portions of the executable file representing the game application 310 and data associated with the game application into memory within game console 110. Operating environment 300 may also manage storage/retrieval of game state for save/load game functionality.

Game application 310 represents one or more software/executable modules containing software instructions and data which on execution provide the various features of the game. Game application 310 is shown containing game definitions 320, which represents the art work (such as images, audio, scripts, etc) and the specific logic of the game and game engine 330 which contains the software/programming instructions facilitating execution of the game (according to the game definitions 320).

Game definitions 320 represent software/data modules implementing the game applications and corresponding logics, as well as object data for various objects provided according to several aspects of the present invention. The game definitions may also contain object data to represent scenes, (part of) content of each scene, the image/audio data corresponding to elements/objects of the game, the manner in which elements interact with each other (typically implemented using scripts), etc. An example implementation of a data structure representing an object is described briefly below with reference to FIG. 4A.

FIG. 4A represents a data structure implemented using C++ like language for an object/element (e.g., bullet 165) in a game. It should be appreciated that such data structures are generally provided in the form of a library, with the developer of the game then creating desired instances of the objects by populating the attributes/variables of the data structure. Thus, as described below, the developer could provide different values for direction for different instances of the bullet (e.g., to ensure that the sound corresponding to one bullet objects is heard by only one user or in one direction, while sound corresponding to another bullet object is heard by one another user or in another direction).

The object data structure indicates that the object definition corresponds to a 3-Dimensional object (for example, the bullet object 165 shown in scene 160) and thus includes variables/attributes such as points, edges corresponding to a 3D display (as shown in lines 412 and 413), the audio stream associated with the element (line 414), location of instance of the element with reference to a scene, typically, with respect to the center of the screen/display (lines 416-418) and color, texture (lines 419 and 420).

As is well known, each 3D object/element can be rendered using co-ordinates of a set of points and/or the vectors representing edges. For example, a solid 3D cube can be rendered using the co-ordinates of 8 points. The color specifies the color of the object/element, while the texture specifies the material or look of the 3D object. For example, the element bullet 165 may be specified as being of golden color and texture as being “metallic shiny”. The developer (or players later) may associate an element with any of existing audio streams or may create a new audio stream in any known formats WAV, MP3, WMI etc for later association with the element.

The attribute “direction” (in line 415), provided according to an aspect of the present invention, specifies the direction of stereoscopic display of the element (as described in step 220). According to an aspect of the present invention, a developer of game application 310 is enabled to specify a static value for the attribute “direction” for desired element types/instances. The developer specified static values may then be used as the direction for stereoscopic rendering of the elements as well as for providing the directional audio signals corresponding to the elements.

In an alternative embodiment, another attribute (such as “syncflag” of type “boolean”) is provided as part of the data structure to enable the developer of the game application to specify whether the directional audio is to be sent in the same direction the element is rendered. Accordingly, the audio and rendered direction may be aligned only for some of the elements in a scene. In the absence of syncFlag attribute as in FIG. 4A, the direction of audio (if there is one associated for the element) may be left to be determined by the program logic otherwise.

In yet another embodiment, an additional attribute (such as “audioDirection” of type “float3”) is provided as part of the data structure to enable the developer to specify a different direction for the directional audio signal (in contrast to the value of the “direction” attribute used for rendering the stereoscopic display).

Value of direction for an associated element may be specified by the developer in any desired manner. One such manner in which the direction is specified as a 3 dimensional vector as shown in an embodiment below with reference to FIG. 4B.

FIG. 4B contains a graphical representation of direction of rendering of the stereoscopic display and provision of the directional audio in one embodiment. The direction is defined in terms of co-ordinates with respect to three axes X, Y and Z (lines 460, 470 and 480), with the origin O at the intersection of the three axes. Accordingly, a developer may specify the value of direction attribute (in line 415) as three values respectively corresponding to the X, Y, and Z co-ordinates (as indicated by the “float3” type). Alternative approaches such as specifying angles with respect to the three axes X, Y, and Z respectively, may be used.

Point P (490) indicates a point represented by corresponding values of (X, Y, Z) which corresponds to a direction in which the element is to be rendered and the corresponding directional audio is to be provided. It may be appreciated that though the stereoscopic display rendered on display unit 120 may be visible to viewers in the area in front of the display unit, the specific element being rendered in the direction P is directed to the portion 495 of the view area.

Similarly, the directional audio signal corresponding to the specific element is provided in the same direction P such that the audio signal travels to portion 495 only and not to portions that are away from portion 495 in the view area. Thus, in the example of FIG. 1B, the direction audio would be directed (or sent towards) only player 180B, but not player 180A since player 180A is away from the portion 495, where player 180B is located. While such an objective is described as being obtained by vectors/angles in the description above, any attempts to send the signal towards player 180B, but not to player 180A is generally assumed to be the same direction as the direction of the visual rendering of the element.

It may be observed that the origin 0 is shown as being in the center of stereoscopic display unit 120. However, in other embodiments, the location of origin O can be located at other points such as the bottom-right corner of display unit 120, another element/object in the scene, etc. For example, in a scenario that the direction/point P is specified in relation to an object at location (x′, y′, z′) coordinates, then the coordinates of point P′ (representing the effective direction relative to origin 0) has to be calculated based on the (x′, y′, z′) co-ordinates.

Continuing with FIG. 3, game engine 330 facilitates execution of the game according to the data contained in game definitions 320. Game engine 330 may facilitate functions such as Internet access, interfacing with file systems via operating environment 300 (to load/save the status of games while playing the game), etc. Game engine 330 may also interface with operating environment 300 to receive inputs (via path 114) by execution of corresponding instructions. In addition, game engine 330 generates video data and audio stream based on the specific object data in game definitions 320 for a corresponding scene. Each block of game engine 330 performing one or more of the above functions is described in detail below.

Loader 370 retrieves and loads (as in step 220) either all or portions of game definitions 320 into game models 360 depending on specific parameters such as “complexity level” selected by the player, current level (of game) the player is in, etc. For example scene 160, loader 370 may generate (or instantiate) two instances of role objects corresponding to role A and role B and instances of the bullet object for rendering of the corresponding elements such as players 162, and 168, the flower pot 164 and bullet 165 as part of scene 160.

Game models 360 stores/maintains state information (in RAM within game console 110) which may include data structures indicating the state (current and any previous state) of objects/elements in the game. For example, the data structures for a present state may include data representing the present scene (such as scene 160), elements (such as role 162, role 168, flower pot 164 and bullet 165) in the scene and details of each element (e.g., location of each element in the scene, the history of interactions that have occurred on each element/object), etc.

Event generator 340 generates events/notifications (sent to interaction processor 350) in response to receiving inputs (via path 114) and/or based on time. The notifications may be generated based on the identifier(s) of the player(s), specific controls (if any) pressed by the player(s). The notifications may also be generated based on any control information such as system time, elapsed time for the game etc. Interaction processor 350 operates in conjunction with event generator 340 in order to determine the specific impact on the elements/objects in the current state/scene of the game (maintained in game models 360) using techniques such as collision detection, impact analysis, etc. Interaction processor 350 then updates the data in game models 360 such that the object data in game models reflects the impacted new state of the elements in the scene.

Furthermore, according to an aspect of the present invention, interaction processor 350 determines the direction in which an element (such as bullet 165) is to be stereoscopic rendered (step 220). The determination may be performed based on the static values specified in the object data by the developer of the application (as part of game definitions 320).

Alternatively, interaction processor 350 may dynamically (based on the game logic) determine a direction of the path the element (bullet 165) is to take based on the interaction (e.g., firing towards role B 168) associated with the element. For example, the game application (logic) may be designed to fire bullet object 165 in the direction vector (5, 7, 3) relative to the position of the object firing the bullet (role 162) in the screen. Thus, in the scenario that the original object (role 162) is located at (x, y, z) on the screen (with a positive value of z indicating that the object is stereoscopic), the direction of bullet 165 may be determined to be the vector ((x+5), (y+7), (z+3)). In general if the direction vector is provided as (x′, y′, z′), the direction of bullet 165 may be determined as the vector ((x+x′), (y+y′), (z+z′)). It should be appreciated that the determination of the direction (the static specification by the developer) may take into account the location of the speakers/audio output devices and the physical location of the players/viewers.

Interaction processor 350 then updates the direction attribute contained in the object data of the element (maintained as part of game models 360). For the above example, the three values of direction attribute may be set as direction.x=x+5, direction.y=y+7, and direction.z=z+3 (or in general to the respective values x+x′, y+y′ and z+z′). The attribute value may then be retrieved and used by rendering engine 380 to render the stereoscopic display in the determined direction and audio generator 390 to provide the directional audio signal in the same direction as described in detail below.

In case multiple elements (e.g., water thrown along with a bullet shot) are rendered to emerge out simultaneously, the corresponding directions may be determined and the object data for other elements may be processed similarly. In such a case, the set of audio signals that need to be sent in each direction may be determined, and such signals may be suitably mixed.

Rendering engine 380 interacts and polls data contained in game models 360 in order to determine changes in the present state of the objects/elements. Based on determination of a change in the present state (for example, in response to a user input), rendering engine 380 enables rendering of elements of a scene on display unit 120 by providing the corresponding image data in path 112 using operating environment 300 (hardware, drivers, etc.,) within game console 110. In case of rendering of 3-D objects on a stereoscopic display unit 120, image data sent in path 112 may include data representing additional attributes of the corresponding object which determines the relative depth of the element, the relative location of each element, etc. to cause specific elements to be stereoscopically displayed in specific directions (step 250) as indicated by the object data.

Audio generator 390 sends audio stream in path 113 using drivers/systems provided by operating environment 300 within game console 110. The audio stream for an element is provided in time-correlation (synchronous generally, but delay may be varied for various desired game effects) with rendering of the corresponding element. In one embodiment, audio generator 390 retrieves audio stream (based on the value of the variable “audioStream” of line 414) and the corresponding direction based on object data contained in game models 360 (and/or game definitions 320) and provides the audio stream in the specified direction for the object in the scene (as in step 280).

For example, audio generator 390 may be designed to modulate the original audio stream with an ultrasound signal and to provide the modified/combined audio signal in path 113 to the directional audio output device 130, which in turn may contain ultrasound transducers (e.g., with rotational capability) to project the received modified audio signals in the desired/specified direction (based on the object data). Alternatively, audio generator 390 may send the original audio stream and the desired direction to an intermediate device (such as an amplifier, not shown) which in turn processes/modulates the audio stream and forwards the modified audio signal to directional audio output device 130.

Thus, the audio is reproduced in a direction that correlates with the stereoscopic display of the object in the scene. In particular, when the objects in a scene appear to emerge in a specific direction, the providing of audio in the same direction causes players and/or users in the vicinity of the object to hear the audio correlated with the visual rendering of the element thereby enhancing user experience.

While the description above is provided with respect to an environment, where, multiple users/teams may be associated with a game console in a location, the features can be implemented in gaming environments where several users may access a game console from multiple different locations over a network. In such a scenario, interactions may be received into game console over the network and corresponding response indicating the direction and audio may be sent to the users via the same network in order to provide the audio in a direction which is correlated with the direction of the object.

It should be appreciated that the above-described features may be implemented in a combination of one or more of hardware, software, and firmware (though embodiments are described as being implemented in the form of software instructions). The description is continued with respect to an embodiment in which various features are operative by execution of corresponding software instructions.

6. Digital Processing System

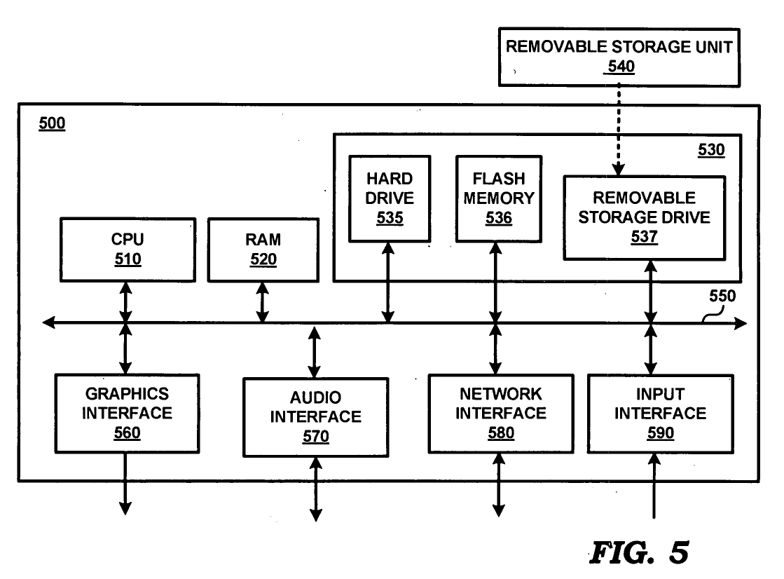

FIG. 5 is a block diagram illustrating the details of digital processing system 500 in which various aspects of the present invention are operative by execution of appropriate software instructions. Digital processing system 500 may correspond to game console 110.

Digital processing system 500 may contain one or more processors such as a central processing unit (CPU) 510, random access memory (RAM) 520, secondary memory 530, graphics interface 560, audio interface 570, network interface 580, and input interface 590. All the components may communicate with each other over communication path 550, which may contain several buses as is well known in the relevant arts. The components of FIG. 5 are described below in further detail.

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit. RAM 520 may receive instructions from secondary memory 530 using communication path 550.

Graphics controller 560 generates display signals (e.g., in RGB format, format required for stereoscopic display) to display unit 120 based on data/instructions received from CPU 510. The display signals generated may cause display unit 120 to provide stereoscopic display of the scenes (as described above with respect to FIG. 1B). Audio interface 570 generates audio signals to audio output device (such as 130) based on the data/instructions received from CPU 510. The audio signals generated may cause the audio output device to reproduce the audio in a corresponding direction (for example, the direction specified in FIG. 4B). Accordingly, audio interface may send signals representing the audio content to be broadcast as well as information indicating the direction.

Network interface 580 provides connectivity to a network (e.g., using Internet Protocol), and may be used to communicate with other connected systems (such as other game consoles associated with players on another location). Input interface 590 may correspond to a keyboard, a pointing device (e.g., touch-pad, mouse), game controllers 140A-140B and may be used to provide inputs (e.g., such as those required for the playing the game, to start/stop of execution of a game application, etc.).

Secondary memory 530 may contain hard drive 535, flash memory 536, and removable storage drive 537. Secondary memory 530 may store the data (e.g., game models 360, game definitions 320, player profiles, etc.) and software instructions, which enable digital processing system 500 to provide several features in accordance with the present invention.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention.

7. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of enhancing user experience of audio-visual content provided by a system, said method being implemented in said system, said method comprising:
rendering an element as a stereoscopic display visible to viewers in an area, said element being rendered in a direction such that said element is directed to a first portion of said area; and
providing a directional audio signal corresponding to said element also in said same direction such that said directional audio signal travels to said first portion but not to portions that are away from said first portion in said area.

2. The method of claim 1, wherein said directional audio signal is played in time correlation with said rendering.

3. The method of claim 2, wherein an object data for said element specifies whether the direction of said directional audio signal should or not be the same as the direction of said rendering of said element,
wherein said directional audio signal is provided in said same direction if said object data specifies that the direction of said directional audio signal should be the same as the direction of said rendering of said element.

4. The method of claim 3, wherein said object data further indicates said direction as a static value which is provided by a developer.

5. The method of claim 3, wherein said object data further comprises a direction attribute for said direction, said method further comprising:
determining a first direction of a path said element is to take based on an interaction associated with said element; and
storing said first direction as a value of said direction attribute,
wherein said rendering and said providing are performed after said storing.

6. The method of claim 5, wherein said system is a game console and said interaction is in response to a user input.

7. The method of claim 6, wherein said element is rendered as a part of a scene generated according to a gaming logic underlying a game application and also according to said user input.

8. The method of claim 7, wherein said element is a bullet, said user input represents shooting a gun, and a sound of said gun is heard by only a subset of players playing a game corresponding to said game application due to said providing of said directional audio signal in said direction only.

9. A computer readable medium storing one or more sequences of instructions causing a system to provide enhanced user experience of audio-visual content, wherein execution of said one or more sequences of instructions by one or more processors contained in said system causes said system to perform the actions of:
rendering an element as a stereoscopic display visible to viewers in an area, said element being rendered in a direction such that said element is directed to a first portion of said area; and
providing a directional audio signal corresponding to said element also in said same direction such that said directional audio signal travels to said first portion but not to portions that are away from said first portion in said area.

10. The computer readable medium of claim 9, wherein said directional audio signal is played in time correlation with said rendering.

11. The computer readable medium of claim 10, wherein an object data for said element specifies whether the direction of said directional audio signal should or not be the same as the direction of said rendering of said element,
wherein said directional audio signal is provided in said same direction if said object data specifies that the direction of said directional audio signal should be the same as the direction of rendering of said element.

12. The computer readable medium of claim 11, wherein said object data further indicates said direction as a static value which is provided by a developer.

13. The computer readable medium of claim 12, wherein said object data further comprises a direction attribute for said direction, further comprising one or more instructions for:
determining a first direction of a path said element is to take based on an interaction associated with said element; and
storing said first direction as a value of said direction attribute,
wherein said rendering and said providing are performed after said storing.

14. The computer readable medium of claim 13, wherein said system is a game console and said interaction is in response to a user input.

15. The computer readable medium of claim 14, wherein said element is rendered as a part of a scene generated according to a gaming logic underlying a game application and also according to said user input.

16. The computer readable medium of claim 15, wherein said element is a bullet, said user input represents shooting a gun, and a sound of said gun is heard by only a subset of players playing a game corresponding to said game application due to said providing of said directional audio signal in said direction only.

17. An audio-visual system comprising:
a rendering block to render an element as a stereoscopic display visible to viewers in an area, said element being rendered in a direction such that said element is directed to a first portion of said area; and
an audio generator block to provide a directional audio signal corresponding to said element also in said same direction such that said directional audio signal travels to said first portion but not to portions that are away from said first portion in said area.

18. The audio-visual system of claim 17, further comprising a memory to store an object data for said element,
wherein said object data specifies whether the direction of said directional audio signal should or not be the same as the direction in which said rendering block renders said element,
wherein said audio generator block provides said directional audio signal in said same direction if said object data specifies that the direction of said directional audio signal should be the same as the direction in which said rendering block renders said element.

19. The audio-visual system of claim 18, further comprising:
a non-volatile storage to store game definitions provided by a developer, wherein said game definitions includes a static value for said direction; and
a loader block to load said static value for said direction into said object data for said element.

20. The audio-visual system of claim 18, wherein said object data further comprises a direction attribute for said direction, said audio-visual system further comprising:
an interaction processor block to determine a first direction of a path said element is to take based on an interaction associated with said element and to store said first direction as a value of said direction attribute,
wherein said rendering block renders said element and said audio generator block provides said directional audio signal after said interaction processor block stores said first direction in said direction attribute.
